(19) United States
(12) Patent Application Publication
(10) Pub. No.: US 2020/0120082 A1
(43) Pub. Date: Apr. 16, 2020

(54) TECHNIQUES FOR SECURING CREDENTIALS USED BY FUNCTIONS

(71) Applicant: Nuweba Labs Ltd., Tel Aviv-Jaffa (IL)

(72) Inventor: Yan CYBULSKI, Tel-Aviv (IL)

(73) Assignee: Nuweba Labs Ltd., Tel Aviv-Jaffa (IL)

(21) Appl. No.: 16/598,239

(22) Filed: Oct. 10, 2019

Related U.S. Application Data
(60) Provisional application No. 62/744,099, filed on Oct. 10, 2018.

(51) Int. Cl. H04L 29/06

(52) U.S. Cl. CPC H04L 63/083; H04L 63/10; H04L 63/1491; H04L 63/0428

(57) ABSTRACT

A system and method for securing credentials utilized by serverless functions. The method includes removing a first set of credentials from a serverless function, wherein the at least one first set of credentials is used to access a service; and replacing, in a request for the service, a second set of credentials with the first set of credentials, wherein the request is intercepted in-line between the serverless function and the service.

### CROSS-REFERENCE TO RELATED APPLICATIONS

This application claims the benefit of U.S. Provisional Application No. 62/744,099 filed on Oct. 10, 2018, the contents of which are hereby incorporated by reference.

### TECHNICAL FIELD

The present disclosure relates generally to protecting credentials used for authentication, and more specifically to securing credentials used by serverless functions to access external services.

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS Lambda by Amazon®, Azure® Functions by Microsoft®, Google Cloud Functions Cloud Platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as microservices. Alternatively, applications can be written to be purely serverless and without using provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be trigged by manually configured events or when a function calls another function. For example, in Amazon® AWS®, such triggers include file (e.g., S3) updates, passage of time (e.g., scheduled tasks), and messages added to a message bus. A programmer of the function would typically have to provide parameters specific to the event source it is tied to.

A serverless function is typically programmed and deployed using command line interface (CLI) tools, an example of which is a serverless framework. In most cases, the deployment is automatic and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed or accessed by the function (e.g., database).

Some serverless platform developers have sought to take advantage of the benefits of software containers. For example, one of the main advantages of using software containers is the relatively fast load times as compared to virtual machines (VMs). However, while load times such as 100 ms may be fast as compared to VMs, such load times are still extremely slow for the demands of FaaS infrastructures.

FIG. 1 shows an example diagram 100 illustrating a FaaS platform 110 providing functions to various services 120-1 through 120-6 (hereinafter referred to as services 120 for simplicity). Each of the services 120 may utilize one or more of the functions provided by software containers 115-1 through 115-4 (hereinafter referred to as a software container 115 or software containers 115 for simplicity). Each software container 115 receives requests from the services 120 and provides functions in response. To this end, each software container 115 includes code of its respective function. When multiple requests for the same software container 115 are received around the same time, a performance bottleneck occurs.

One vulnerability in ephemeral execution environments is caused by the way in which functions are invoked. The ephemeral execution provides, on each execution, a clean environment without any changes that can occur after execution of code begins in order to avoid unexpected bugs or problems due to residual changes. However, providing ephemeral execution environments requires running servers for a prolonged period of time. Some FaaS providers offer environment reuse (container reuse) to compensate for high cold start time (or warm start). However, such reuse poses a risk since the software container maintains persistency when an attacker successfully gain access to a function environment, thereby leaving the reused environment vulnerable to the same attacker access.

Another vulnerability can result from the manipulation of a serverless function's flow. Manipulating the flow can lead to malicious activity, such as remote code execution (RCE), data leaks, malware injections, and the like.

Another vulnerability in FaaS platforms may be caused due to communications from an interface to a network (e.g., the Internet). Today, developers of serverless functions do not have the ability to provide fine-grain control over network traffic flowing in and out of a software container. For example, developers in an Amazon® cloud environment usually bind a Lambda serverless function to a virtual private cloud (VPC) of Amazon® in order to control the function's network traffic. The network traffic is a suitable solution regarding price, performance (heavy performance degradation), and complexity of operation.

Another vulnerability is caused by use of credentials by functions to access external services. For example, one vulnerability may be caused by utilization of environment variables in order to simplify and abstract function configuration and the use of credentials such that accessing the environment of the function will also allow access to the credentials. The environment variables are provided through an API or user interface, and are utilized during invocation of a function. Sometimes the environment variables are stored in a secure way while on rest. Environment variables are also used to pass the function sensitive information, such as third-party credentials to be used inside the function in order to access APIs of third-party providers, such as Slack, GitHub, Twillo, and the like.

A provider of the FaaS platform can also inject, into the environment, the function credentials that grant access to other services inside the provider cloud (in AWS its IAM credentials). The credentials may be injected using environment variables.

Some providers secure the credentials at rest or at runtime, or provide temporary credentials. For example, credentials may be retrieved at runtime and stored in memory. Although these techniques reduce the change of environment variable misuse, utilization of environment variables still poses security risks for the sensitive credentials that are visible inside the function environment. That is, an attacker who gains access to the function environment can leak the credentials and cause real damage to a company even if the credentials are valid for a short period of time (usually 1 hour).

Additionally, existing solutions may present risks due to accidental inclusion of credentials in code uploaded to repositories (e.g., GitHub). Specifically, when in-line secrets are used in production code and pushed to a repository, if the secrets are not replaced then the secrets are exposed. Thus, even otherwise benign entities may cause credentials to leak.

Other vulnerabilities include misconfigured security settings (e.g., web application firewall) and logical vulnerabilities (due to incorrect coding). Such vulnerabilities are difficult to detect because they can appear as regular traffic.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for method for securing credentials utilized by serverless functions. The method comprises: removing a first set of credentials from a serverless function, wherein the at least one first set of credentials is used to access a service; and replacing, in a request for the service, a second set of credentials with the first set of credentials, wherein the request is intercepted in-line between the serverless function and the service.

Certain embodiments disclosed herein also include a non-transitory computer readable medium having stored thereon causing a processing circuitry to execute a process, the process comprising: removing a first set of credentials from a serverless function, wherein the at least one first set of credentials is used to access a service; and replacing, in a request for the service, a second set of credentials with the first set of credentials, wherein the request is intercepted in-line between the serverless function and the service.

Certain embodiments disclosed herein also include a system for securing credentials utilized by serverless functions. The system comprises: a processing circuitry; and a memory, the memory containing instructions that, when executed by the processing circuitry, configure the system to: remove a first set of credentials from a serverless function, wherein the at least one first set of credentials is used to access a service; and replace, in a request for the service, a second set of credentials with the first set of credentials, wherein the request is intercepted in-line between the serverless function and the service.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform providing functions for various services.

FIG. 2 is a diagram illustrating a FaaS platform utilized to describe various disclosed embodiments.

FIG. 3 is a network diagram illustrating deployment of a vault manager according to various disclosed embodiments.

FIG. 4 is a flowchart illustrating a method for securing credentials according to an embodiment.

FIG. 5 is a block diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Although some existing solutions secure credentials, there are still security risks in maintaining visible credentials inside the computing environment of a serverless function. Specifically, an attacker that gains access to the function's environment can leak or use the credentials, which can cause significant damage even if the credentials are only valid for a limited period of time. Thus, it has been identified that a solution which does not involve storing visible credentials in the serverless function environment would be desirable.

The embodiments disclosed herein include techniques for securing credentials in used for authentication by functions, for example in a function as a service (FaaS) platform. More specifically, the disclosed embodiments provide a security layer for securing credentials during execution of serverless functions. The disclosed embodiments include removing original credentials from a serverless function (hereinafter a function or functions) such that the original credentials are not visible within the function. The original credentials may be replaced with decoy credentials. When a request for a service is subsequently made by the function, the decoy credentials are replaced with the original credentials. Thus, the original credentials are not visible within the computing environment in which the function is executed.

The disclosed embodiments may be operable in commercially available FaaS platforms supporting various types of serverless functions such as, but not limited to, Amazon® Web Services (AWS) Lambda® functions, Azure® functions, IBM® Cloud functions, and the like. In an embodiment, the security layers are operable in a secured scalable FaaS platform (hereinafter “the scalable FaaS platform”) designed according to at least some embodiments.

In an embodiment, original credentials to be used by a function are removed from the function. The original credentials may be replaced with decoy credentials. The original credentials are sensitive in that disclosure of the original credentials may result in unauthorized access to data inside or outside of the computing environment in which the function is executed. In an example implementation, the original credentials include variables used to access a service.

The decoy credentials are different from the original credentials such that the decoy credentials cannot be used to access the service and any attempts to access the service using the decoy credentials will fail. The original credentials are stored in a credentials vault deployed outside of a computing environment of the function operates such that, if a malicious entity gains access to the computing environment of the function, the malicious entity will not also be able to access the original credentials.

When a service is requested or accessed by a function using the decoy credentials, the request is intercepted and analyzed to determine whether the requesting entity is the function. If so, the decoy credentials in the request are replaced with the original credentials. Otherwise (e.g., when the requesting entity is an attacker's function), service is denied. In some embodiments, when service is denied to a requesting entity, the requesting entity may be presented with a honeypot service that appears, to the requesting entity, to be the requested service. To this end, the honeypot service may return false service data that is like the data of the actual service (e.g., similar structure, similar tags, similar types of data, etc.).

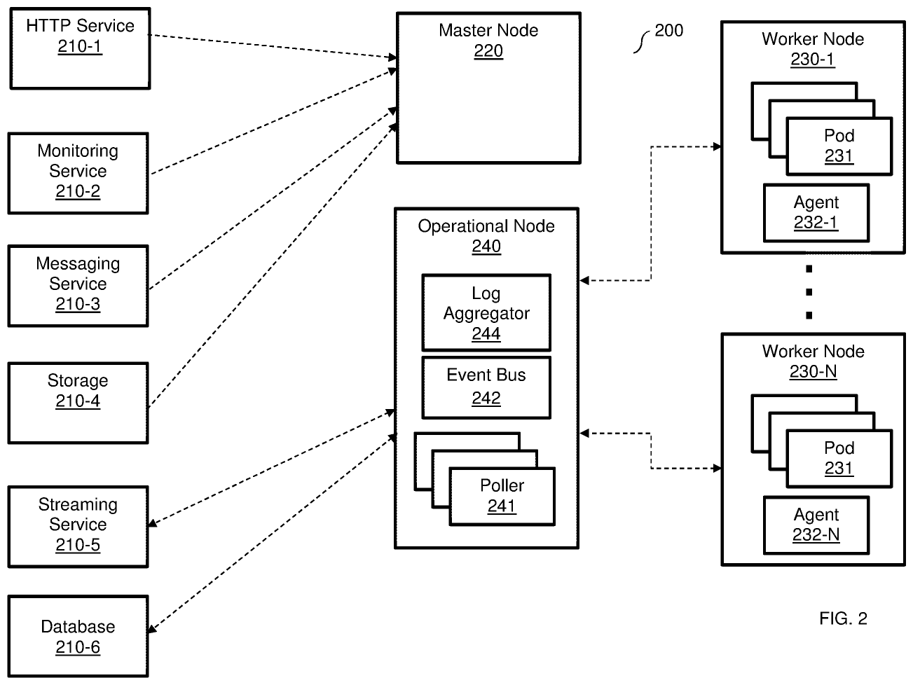

FIG. 2 is an example diagram of a scalable FaaS platform 200 designed according to an embodiment. The scalable FaaS platform 200 is configured to secure execution of serverless functions by implementing processes of the various security layers. It should be noted that the disclosed embodiments are not necessarily limited to serverless functions, and that other types of functions which may use credentials to access services may be protected in accordance with the disclosed embodiments.

In the scalable FaaS platform 200, software container pods are utilized according to the disclosed embodiments. Each pod is a software container including code for a respective serverless function that acts as a template for each pod associated with that serverless function. When a function is called, it is checked if a pod containing code for the function is available. If no appropriate pod is available, a new instance of the pod is added to allow the shortest possible response time for providing the function. In some configurations, when an active function is migrated to a new FaaS platform, a number of initial pods are re-instantiated on the new platform.

In an embodiment, each request for a function passes to a dedicated pod for the associated function. In some embodiments, each pod only handles one request at a time such that the number of concurrent requests for a function that are being served are equal to the number of running pods. Instances of the same pod may share a common physical memory or a portion of memory, thereby reducing total memory usage.

The pods may be executed in different environments, thereby allowing different types of functions in a FaaS platform to be provided. For example, Amazon® Web Services (AWS) Lambda functions, Azure® functions, and IBM® Cloud functions may be provided using the pods deployed in a FaaS platform as described herein. The functions are services for one or more containerized application platform (e.g., Kubernetes®). A function may trigger other functions.

In addition to the various benefits discussed herein, the disclosed scalable FaaS platform 200 further provides an ephemeral execution environment for each invocation of a serverless function. This ensures that each function's invocation is executed to a clean environment, i.e., without any changes that can occur after beginning execution of the code that can cause unexpected bugs or problems. Further, an ephemeral execution environment is secured to prevent persistency in case an attacker successfully gains access to a function environment.

To provide an ephemeral execution environment, the scalable FaaS platform 200 is configured to prevent any reuse of a container. To this end, the execution environment of a software container (within a pod) is completely destroyed at the end of the invocation and each new request is served by a new execution environment. This is enabled by keeping pods warm for a predefined period of time through which new requests are expected to be received.

In an embodiment, the scalable FaaS platform 200 is configured to handle three different types of events that trigger execution of serverless functions. Such types of events include synchronized events, asynchronized events, and polled events. The synchronized events are passed directly to a cloud service to invoke the function in order to minimize latency. The asynchronized events are first queued before invoking a function. The polled events cause an operational node (discussed below) to perform a time loop that will check against a cloud provider service, and if there are any changes in the cloud service, a function is invoked.

In the example embodiment illustrated in FIG. 2, the scalable FaaS platform 200 provides serverless functions to services 210-1 through 210-6 (hereinafter referred to individually as a service 210 or collectively as services 210 for simplicity) through the various nodes 220 through 240. In an embodiment, there are three different types of nodes: master, worker, and operational. In an embodiment, the scalable FaaS platform 200 includes a master node 220, one or more worker nodes 230, and one or more operational nodes 240. In the example implementation shown in FIG. 2, the FaaS platform 200 includes one master node 220, a plurality of worker nodes 230-1 through 230-N (where N is an integer greater than or equal to 2), and one operational node 240.

The master node 220 is configured to orchestrate the operation of the worker nodes 230 and the operational node 240. A worker node 230 includes pods 231 configured to execute serverless functions and may further include a respective agent 232. Each pod 231 is a software container configured to perform a respective function such that any instance of one of the pods 231 contains code for the same function as other instances of the pods 231. The operational node 240 is utilized to run functions for the streaming and database services 210-5 and 210-6. The operational node 240 is further configured to collect logs and data from the worker nodes 230.

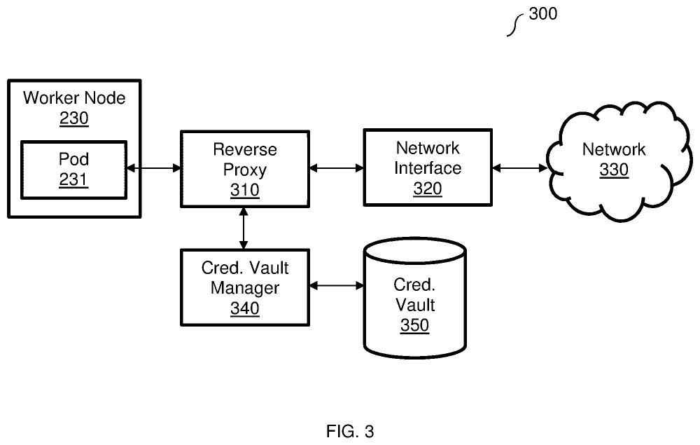

Each agent 232 is configured to at least send information related to operation of the pods 231 of the respective worker node 230. Such information may include, but is not limited to, information related to behaviors of serverless functions executed by the pods 231. In particular, such information may include information related to inputs used by the serverless functions and outputs provided by the serverless functions. the information may be sent, for example, to a reverse proxy (e.g., the reverse proxy 310, FIG. 3).

The operational node 240 includes one or more pollers 241, an event bus 242, and a log aggregator 244. A poller 241 is configured to delay provisioning of polled events indicating requests for functions. To this end, each poller 241 is configured to perform a time loop and to periodically check an external system (e.g., a system hosting one or more of the services 210) for changes in the state of a resource, e.g., a change in a database entry. When a change in state has occurred, the poller 241 is configured to invoke the function of the respective pod 231.

The event bus 242 is configured to allow communication between the other nodes (i.e., the master node 220 and the worker nodes 230) and the other elements (e.g., the poller 241, log aggregator 244, or both) of the operational node 240.

The log aggregator 244 is configured to collect logs and other reports from the worker nodes 230.

The master node 220 further includes a queue, a scheduler, a load balancer, and an auto-scaler (these components not shown in FIG. 2A), utilized during the scheduling of functions. The autoscaler is configured to scale the pod services according to demand based on events representing requests (e.g., from a kernel, for example a Linux kernel of an operating system) and. To this end, the autoscaler is configured to increase the number of instances of the pods 231 that are available as needed, while ensuring low latency. For example, when a request for a function that does not have an available pod is received, the autoscaler increases the number of pods. Thus, the autoscaler allows for scaling the platform per request.

The events may include, but are not limited to, synchronized events, asynchronized events, and polled events. The synchronized events may be passed directly to the pods to invoke their respective functions. The asynchronized events may be queued before invoking the respective functions.

It should be noted that, in a typical configuration, there is a small number of master nodes 220 (e.g., 1, 3, or 5 master nodes), and a larger number of worker nodes 230 and operational nodes 240 (e.g., millions). The worker nodes 230 and operational nodes 240 are scaled on demand.

The nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and the services 210 may be performed over a network, e.g., the internet (not shown in FIG. 2).

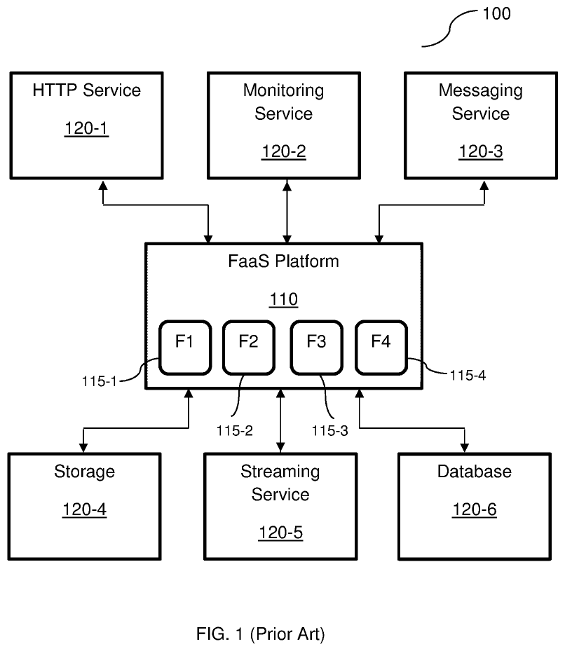

In some implementations, the FaaS platform 200 may allow for seamless migration of functions used by existing customer platforms (e.g., the FaaS platform 110, FIG. 1). The seamless migration may include moving code and configurations to the FaaS platform 200.

It should be noted that the services 220 are merely examples and that more, fewer, or other services may be provided functions by the FaaS platform 210 according to the disclosed embodiments. The services 220 may be hosted in an external platform (e.g., a platform of a cloud service provider utilizing the provided functions in its services). Requests from the services 220 may be delivered via one or more networks (not shown). It should also be noted that the numbers and arrangements of the nodes 211 and the pods 216 are merely illustrative, and that other numbers and arrangements may be equally utilized. In particular, the number of pods 216 may be dynamically changed as discussed herein to allow for scalable provisions of functions.

It should also be noted that the flows of requests shown in FIG. 2 (as indicated by dashed lines with arrows in FIG. 2) are merely examples used to demonstrate various disclosed embodiments and that such flows do not limit the disclosed embodiments.

The FaaS platform 210 may be configured to implement a number of security layers to secure the platform 210, executed pods and functions. The security layers are designed to defend against vulnerabilities such as the vulnerabilities discussed above. To this end, in an embodiment, a reverse proxy may be deployed between the FaaS platform 200 and one or more external networks.

It should be further noted that each of the nodes (shown in FIG. 2) requires an underlying hardware layer (not shown in FIG. 2) to execute the operating system, the pods, load balancers, and other functions of the master node.

FIG. 3 is an example network diagram 300 illustrating deployment of a credentials vault manager 340 according to an embodiment. More specifically, in the example implementation shown in FIG. 3, a reverse proxy 310 is deployed between the pod 231 and a network interface 320. The reverse proxy 310 communicates with a credentials (cred.) vault manager 340. The network interface 320 provide access to the network 330. The network 330 may be, for example, the Internet, an internal service network (i.e., an intranet), and the like. In an example implementation, input and output data of the pods 231 is communicated via the network 330.

In some implementations, the reverse proxy 310 is configured to provide a security layer designed to defend against malicious activity. To this end, the reverse proxy 310 is configured to provide network security for serverless functions (i.e., serverless functions provided via the pods 231). The reverse proxy 310 may be configured to inspect traffic communicated through the network interface 320 and to learn function behaviors during a learning period in order to generate rules designed to recognize abnormal or unknown network activities.

In an embodiment, the reverse proxy 310 is configured to intercept communications between the pods 231 and the network 320. The intercepted communications include requests for services and, more specifically, requests including decoy credentials as described herein. The reverse proxy 310 may be configured to provide the intercepted requests to the credentials vault manager 340 for inspection and replacement of the decoy credentials.

The credentials vault manager 340 is configured to replace original credentials of a function (e.g., a serverless function executed by the pod 231) with decoy credentials and to replace the decoy credentials with the original credentials in intercepted requests for a service available via the network 330. The credentials vault manager 340 may be configured to store the original credentials in an credentials vault 350.

The credentials vault 350 is at least a portion of storage in which the original credentials are stored. When the decoy credentials need to be replaced with the original credentials, the credentials vault manager 340 is configured to retrieve the original credentials from the credentials vault 350. In an embodiment, the credentials vault 350 is located outside of the FaaS platform 200 such that unauthorized access to the FaaS platform 200 or any components therein will not result in accessing the original credentials.

In some implementations, the credentials vault 350 may be a vault provided by a third-party service (not shown). To this end, the credentials vault 350 may independently (i.e., in addition to the techniques described herein) be configured with security features for protecting credentials stored therein. This further reduces the likelihood that credentials are leaked or misused.

It should be noted that a single pod 231 and a single worker node 230 are illustrated in FIG. 3 rather than multiple pods or the entire FaaS platform 200 merely for simplicity purposes and without limiting the disclosed embodiments. Likewise, a single network 330 is shown merely for simplicity purposes.

In some example embodiments, the vault manager can be implemented as one or more pods in a master node (220) and/or operation node 240. As noted above, each such node requires an hardware layer for execution.

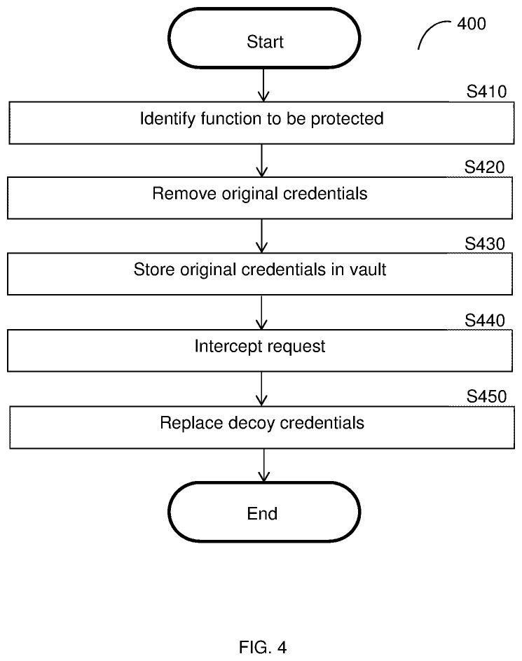

Operation of the credentials vault manager 340 is now described with respect to FIG. 4. FIG. 4 is an example flowchart 400 illustrating a method for securing credentials in a FaaS platform according to an embodiment. In an embodiment, the method is performed by the credentials vault manager 340, FIG. 3.

At S410, a function to be protected is identified. The function to be protected includes one or more original credentials used for accessing data (e.g., data of a service inside or outside of the computing environment in which the function is executed). In an example implementation, the identified function is a newly created serverless function. To this end, S410 may include detecting the creation of the function.

The original credentials include credentials that are sensitive, i.e., that may allow unauthorized access to data when misused. In an embodiment, the original credentials include variables used to access one or more services inside or outside of the computing environment in which the function is executed. The service is a function which provides computing resources (e.g., data) that are used to complete tasks by the function.

As a non-limiting example, the original credentials may include third-party credentials used to access a third-party application programming interface (API) outside of a computing environment in which a function is executed. As another non-limiting example, the original credentials may include credentials used to access services within the computing environment in which a function is executed.

At S420, one or more first original credentials of the identified function are removed from the function. The original credentials include the credentials needed to access the external entity such that authentication to the external entity succeeds when the original credentials are used in a request to the service. In an embodiment, S420 includes removing the credentials from environment variables, files, or code of the function, or a combination thereof.

In an embodiment, S420 further includes replacing the original credentials with decoy credentials. The decoy credentials are different from the original credentials and cannot be used to access the external entity. Thus, when the decoy credentials are used in a request to the external entity, authentication to the external entity fails.

In an embodiment, S420 includes removing the original credentials prior to invocation of the function. Thus, when the function is invoked by an attacker, the invoked function will not include the original credentials.

In a further embodiment, the original credentials are removed prior to runtime of the function by adding a software package to the function and importing the software package into user code. To this end, a user of the function may be required to add the package to the code manually. For example, when the entity implementing the vault manager (e.g., the credentials vault manager 340) does not control the environment in which the function is deployed or otherwise is unable to add the software function to the code, a user is required to add the package. Alternatively, an environment variable that signals to the function to load another software package at runtime may be added to the function. In some embodiments, the loaded software package may include the decoy credentials, thereby replacing the original credentials with the decoy credentials.

In another embodiment, S420 includes modifying the function at runtime. The function may be modified at runtime by, for example, using a supported functionality of the computing environment of the function. As a non-limiting example, such a supported functionality may be an Amazon® Web Services (AWS) lambda custom runtime API. Alternatively, the function may be modified at runtime by inserting a runtime-in-the-middle function, i.e., a custom runtime function to be invoked by the function when runtime of the function has begun. The runtime-in-the-middle function, in turn, invokes and controls the function such that the original credentials can be replaced or removed.

At optional S430, the original credentials are stored in a credentials vault (e.g., the credentials vault 350, FIG. 3). The credentials vault is any storage used to hold at least credentials, and is typically a secure storage location (e.g., requires authentication, is in a secure computing environment, etc.).

In an embodiment, the credentials vault is deployed outside of the computing environment in which the function is executed. In a further embodiment, the credentials vault is not accessible to entities via the computing environment (e.g., the credentials vault may require a separate authentication and is not otherwise accessible to an entity by accessing the computing environment of the function). As a result, in such an embodiment, any entity accessing the computing environment of the function does not therefore also gain access to the original credentials.

At S440, when the original credentials in the function have been replaced with the decoy credentials, a request for the external entity is intercepted. In an embodiment, S440 may further include inspecting the request to determine whether the intercepted request includes the decoy credentials and, if so, execution continues with S450. If the request includes the original credentials or otherwise does not include the decoy credentials, execution may terminate or continue with the next request. It should be noted that, in some embodiments, the request may be intercepted by another component (e.g., the reverse proxy 310, FIG. 3).

At S450, when the request is from the identified function, the decoy credentials in the request are replaced with the original credentials. In an embodiment, S450 includes retrieving the original credentials from the credentials vault, identifying the decoy credentials in the request, and replacing the retrieved original credentials with the decoy credentials identified in the request.

It should be noted that, in various implementations, when the request is not from the identified function, the request will not be intercepted and, therefore, will not have its decoy credentials replaced. As a result, service is denied to the requesting entity that sent the request. Specifically, in the example embodiment shown in FIG. 3, the credentials vault manager 340 replaces decoy credentials in requests intercepted using a reverse proxy 310 deployed in-line between the pod 231 and the network 330. If a function is deployed out-of-line of the pod 231 and the network 330, the function's requests would not be intercepted and modified as described herein. The original credentials may be further protected by placing restrictions on creations of functions in, for example, the worker node 230. As a non-limiting example, new functions may be prevented from being created unless explicit permission is granted.

In an embodiment, the decoy credentials may authenticate to a honeypot service rather than simply failing to authenticate to any service. The honeypot service returns false service data in response to the request. The false service data shares one or more characteristics of legitimate data related to the requested service. Accordingly, data returned by the honeypot service appears to the requesting entity to be legitimate data from the requested service. This false data may allow for, among other things, tracking the attacker. Specifically, if the false data is later used or published, the user or publisher may be identified as the attacker. To this end, in some implementations, the decoy credentials may be rotated or otherwise changed periodically in order to allow for more precise identification in the event that more than one attacker gains access to the computing environment of the function.

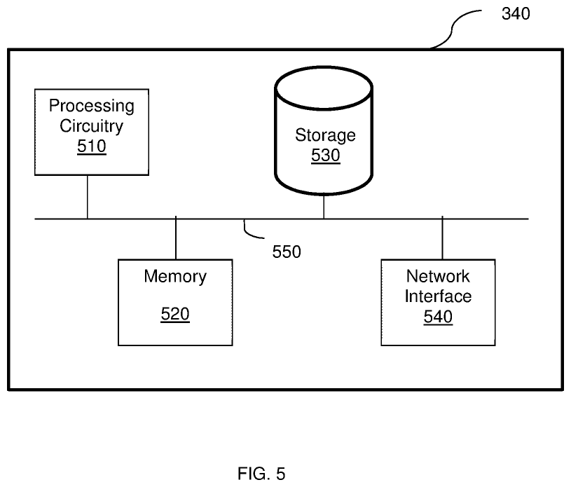

FIG. 5 is an example block diagram of a hardware layer 500 included in each node according to an embodiment. That is, each of the master node, operational node, and worker node is independently executed over a hardware layer, such as the layer shown in FIG. 5. To this end, the disclosed embodiments (e.g., activities performed by the credentials vault manager 340) may be executed over the hardware layer 500.

The hardware layer 500 includes a processing circuitry 510 coupled to a memory 520, a storage 530, and a network interface 540. In another embodiment, the components of the hardware layer 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, configure the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the hardware layer 500 to communicate over one or more networks, for example, to receive requests for functions from user devices (not shown) for distribution to software containers (e.g., the pods 231, FIG. 2).

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for securing credentials utilized by serverless functions, comprising:
removing a first set of credentials from a serverless function, wherein the at least one first set of credentials is used to access a service; and
replacing, in a request for the service, a second set of credentials with the first set of credentials, wherein the request is intercepted in-line between the serverless function and the service.

2. The method of claim 1, further comprising:
replacing, in the serverless function, the removed first set of credentials with the second set of credentials.

3. The method of claim 1, wherein authentication to the service succeeds when the authentication uses the first set of credentials, wherein authentication to the service fails when the authentication uses the second set of credentials.

4. The method of claim 1, further comprising:
storing the first set of credentials in a credentials vault, wherein the serverless function is executed in a computing environment, wherein the credentials vault is deployed outside of the computing environment.

5. The method of claim 4, further comprising:
retrieving the first set of credentials from the credentials vault when the request for the service is intercepted.

6. The method of claim 5, wherein replacing the second set of credentials in the request further comprises:
identifying the second set of credentials in the request, wherein the identified second set of credentials in the request is replaced with the retrieved first set of credentials.

7. The method of claim 1, wherein the second set of credentials authenticates to a honeypot service, wherein the honeypot service returns false service data in response to the request.

8. The method of claim 1, wherein the first set of credentials is removed prior to runtime of the serverless function, wherein removing the first set of credentials further comprises:
causing a software package to be loaded by the serverless function, wherein the loaded software package is configured to remove the first set of credentials.

9. The method of claim 1, wherein removing the first set of credentials further comprises:
modifying the serverless function at runtime, wherein the modified serverless function is controlled to remove the first set of credentials.

10. A non-transitory computer readable medium having stored thereon instructions for causing a processing circuitry to execute a process, the process comprising:
removing a first set of credentials from a serverless function, wherein the at least one first set of credentials is used to access a service; and
replacing, in a request for the service, a second set of credentials with the first set of credentials, wherein the request is intercepted in-line between the serverless function and the service.

11. A system for securing credentials utilized by serverless functions, comprising:
a processing circuitry; and
a memory, the memory containing instructions that, when executed by the processing circuitry, configure the system to:
remove a first set of credentials from a serverless function, wherein the at least one first set of credentials is used to access a service; and
replace, in a request for the service, a second set of credentials with the first set of credentials, wherein the request is intercepted in-line between the serverless function and the service.

12. The system of claim 11, wherein the system is further configured to:
replace, in the serverless function, the removed first set of credentials with the second set of credentials.

13. The system of claim 11, wherein authentication to the service succeeds when the authentication uses the first set of credentials, wherein authentication to the service fails when the authentication uses the second set of credentials.

14. The system of claim 11, wherein the system is further configured to:
store the first set of credentials in a credentials vault, wherein the serverless function is executed in a computing environment, wherein the credentials vault is deployed outside of the computing environment.

15. The system of claim 14, wherein the system is further configured to:
retrieve the first set of credentials from the credentials vault when the request for the service is intercepted.

16. The system of claim 15, wherein the system is further configured to:
identify the second set of credentials in the request, wherein the identified second set of credentials in the request is replaced with the retrieved first set of credentials.

17. The system of claim 11, wherein the second set of credentials authenticates to a honeypot service, wherein the honeypot service returns false service data in response to the request.

18. The system of claim 11, wherein the first set of credentials is removed prior to runtime of the serverless function, wherein the system is further configured to:
cause a software package to be loaded by the serverless function, wherein the loaded software package is configured to remove the first set of credentials.

19. The system of claim 11, wherein the system is further configured to:
modify the serverless function at runtime, wherein the modified serverless function is controlled to remove the first set of credentials.
